(19) United States
(12) Patent Application Publication
(10) Pub. No.: US 2018/0015422 A1
(43) Pub. Date: Jan. 18, 2018

(54) WATER TREATMENT APPARATUS

(71) Applicant: MITSUBISHI HEAVY INDUSTRIES, LTD., Tokyo (JP)

(72) Inventors: Shintaro Taura, Tokyo (JP); Toshio Sao, Nagasaki-shi (JP)

(73) Assignee: MITSUBISHI HEAVY INDUSTRIES, LTD., Tokyo (JP)

(21) Appl. No.: 15/524,173

(22) PCT Filed: Dec. 8, 2014
(86) PCT No.: PCT/JP2014/082459

§ 371 Date: May 3, 2017

(51) Int. Cl. B01D 65/08; C02F 1/44; B01D 61/02; C02F 1/52; C02F 1/66; C02F 1/50; C02F 103/08

(52) U.S. Cl. CPC B01D 65/08; C02F 1/66; C02F 1/441; C02F 1/50; B01D 61/025; C02F 1/52; C02F 2103/08; C02F 2303/04; C02F 2303/20

(57) ABSTRACT

A water treatment apparatus includes a flow channel in which waters to be treated 100a to 100g circulate, bactericide injection means 2 for injecting a chlorine-based bactericide 2a in an injection position 2A of the flow channel, and reverse osmosis membrane modules 12 and 13 which are disposed in the flow channel on a downstream side from the injection position 2A and have reverse osmosis membranes 12b and 13b. In the flow channel, at least one kind of metal or metal compound selected from metals or metal compounds described in (1), (2), and (3) is disposed as a catalyst between the injection position and the reverse osmosis membrane modules.
(1) Metals that belong to group 8 elements, group 9 elements, and group 10 elements
(2) Metals that belong to group 2 elements
(3) Hydroxides, oxides, carbonates, and sulfates as metal compounds of the respective metals described in (1) and (2)

### TECHNICAL FIELD

The present invention relates to a water treatment apparatus in which a chlorine-based bactericide is injected into water to be treated and which includes a reverse osmosis membrane.

### BACKGROUND ART

In recent years, a water treatment apparatus using a reverse osmosis membrane has become widespread. In the water treatment apparatus using a reverse osmosis membrane, if aquatic organisms such as microorganisms are contained in the water to be treated, the aquatic organisms multiply, adhere to the reverse osmosis membrane, and deteriorate the permeability of the reverse osmosis membrane. Therefore, a bactericidal treatment is performed by injecting a chlorine-based bactericide into the water to be treated. If the chlorine-based bactericide remains in the water to be treated, due to the bactericide, the reverse osmosis membrane is oxidized and deteriorates. Accordingly, the time when the bactericidal treatment will be finished is estimated, and a reductant such as sodium bisulfite (hereinafter, referred to as SBS) is injected using an injection device into the water to be treated such that the bactericide in the water to be treated is reduced (becomes harmless) (for example, see PTL 1).

PTL 2 describes a technique not using a reverse osmosis membrane, in which a chlorine-based oxidant is added to organic matter-containing water to be treated, and the water is passed through a manganese-based filter material such that the organic matters are directly oxidized and decomposed.

### CITATION LIST

### Patent Literature

[PTL 1] Japanese Unexamined Patent Application Publication No. 09-057076

[PTL 2] PCT Japanese Patent Domestic Republication No. WO2010/109838

### SUMMARY OF INVENTION

### Technical Problem

The technique disclosed in PTL 1 has the following problems.

That is, (1) in a case where SBS is not injected into the water to be treated due to the failure of the injection device, (2) in a case where SBS is not sufficiently stirred in the water to be treated even if SBS is injected into the water to be treated, and (3) in a case where the amount of SBS injected is insufficient relative to the amount of the bactericide, the bactericide remains in the water to be treated, and due to the remaining bactericide, the reverse osmosis membrane is oxidized and deteriorates. As a result, the quality of the water to be treated having passed through the reverse osmosis membrane deteriorates.

Furthermore, in a case where organic matters are contained in the water to be treated, even if a general water treatment facility such as a filtering device is provided on the upstream side of the reverse osmosis membrane, it is difficult to remove the organic matters with the general water treatment facility, and hence the organic matters reach and adhere to the reverse osmosis membrane. If the organic matters adhere to the reverse osmosis membrane, the amount of water to be treated by the reverse osmosis membrane is reduced.

If the reverse osmosis membrane deteriorates or the organic matters adhere thereto as described above, the reverse osmosis membrane needs to be frequently replaced. Consequently, unfortunately, the running cost of the water treatment apparatus increases, or the operation rate of the water treatment apparatus is reduced.

In addition, unfortunately, for injecting SBS, the initial cost or the running cost is incurred.

In the technique disclosed in PTL 2, the chlorine-based oxidant for removing the organic matters from the water to be treated and a facility for adding the chlorine-based oxidant have to be specially prepared. Accordingly, unfortunately, for adding the chlorine-based oxidant, the initial cost or the running cost is incurred.

The present invention has been made in consideration of the above problems, and an object thereof is to provide a water treatment apparatus which makes it possible to prevent the deterioration of a reverse osmosis membrane and prevent the adherence of organic matters to the reverse osmosis membrane while suppressing an increase in cost.

### Solution to Problem

[1] In order to achieve the aforementioned object, a water treatment apparatus of the present invention includes a flow channel in which water to be treated circulates, bactericide injection means for injecting a chlorine-based bactericide in an injection position of the flow channel, reverse osmosis membrane modules which are disposed in the flow channel on a downstream side from the injection position in a circulation direction of the water to be treated and have reverse osmosis membranes.

In the flow channel, at least one kind of metal or metal compound selected from metals or metal compounds described in the following (1), (2), and (3) is disposed as a catalyst between the injection position and the reverse osmosis membrane modules.

(1) Metals that belong to group 8 elements, group 9 elements, and group 10 elements

(2) Metals that belong to group 2 elements

(3) Hydroxides, oxides, carbonates, and sulfates as metal compounds of the respective metals described above in (1) and (2)

[2] It is preferable that, in the flow channel, mixing acceleration means for accelerating mixing of the bactericide with the water to be treated is provided between the injection position and the catalyst.

[3] It is preferable that, in the flow channel, a filter material is provided between the mixing acceleration means and the reverse osmosis membrane modules, and the catalyst is fixed to at least a portion of the filter material.

[4] It is preferable that, in the flow channel, a filter material is provided between the catalyst and the reverse osmosis membrane modules.

[5] It is preferable that, in the flow channel, a filter material is provided between the mixing acceleration means and the reverse osmosis membrane modules, and the catalyst is fixed to a portion that supplies the water to be treated to the filter material of the flow channel.

[6] It is preferable that, in the flow channel, a filter material is provided between the mixing acceleration means and the reverse osmosis membrane modules, a net-like substance is disposed above the filter material, and the catalyst is fixed to the net-like substance.

[7] The net-like substance is preferably disposed so as to sink in a water layer formed of the water to be treated on the filter material.

[8] The water treatment apparatus preferably further includes catalyst supply means for supplying the catalyst to the flow channel.

[9] It is preferable that, in the flow channel, a filter material is provided between the mixing acceleration means and the reverse osmosis membrane modules, and the catalyst is supplied from the catalyst supply means to the portion that supplies the water to be treated to the filter material of the flow channel.

[10] The catalyst preferably has a specific gravity greater than a specific gravity of the filter material.

[11] The metal that belongs to group 8 elements is preferably iron, the metal that belongs to group 9 elements is preferably cobalt, the metal that belongs to group 10 elements is preferably nickel, and the metals that belong to group 2 elements are preferably magnesium, calcium, strontium, and barium.

In the present invention, the flow channel of the water to be treated includes not only an intake channel or a flow channel between constituent devices of the water treatment apparatus, but also a circulation portion of the water to be treated inside each of the constituent devices. Accordingly, because the water to be treated also circulates into, for example, the filter material, the space occupied by the filter material is also included in the flow channel, and the fixing of the catalyst to the filter material is the disposition of the catalyst in the flow channel.

Furthermore, the aspect in which the catalyst is disposed in the flow channel is not limited to the aspect in which the catalyst is fixed to the flow channel by means of coating and the like, and includes an aspect in which the catalyst is not completely fixed to the flow channel such that the catalyst is injected into and then moves in the flow channel.

### Advantageous Effects of Invention

According to the present invention, the chlorine-based bactericide injected into the water to be treated undergoes a decomposition reaction due to the action of a catalyst, and hence a reactive oxygen radical is generated. Consequently, by the reactive oxygen radical, the organic matters in the water to be treated can be oxidized and decomposed.

By using the bactericide that has been injected into the water to be treated in the related art for removing aquatic organisms, it is possible to decompose the organic matters with a simple constitution in which the catalyst is disposed in the flow channel. Furthermore, because the chlorine-based bactericide is decomposed due to the action of the catalyst, even if the facility for removing the chlorine-based bactericide that has been used in the related art is not provided, the deterioration of the reverse osmosis membrane can be prevented.

Therefore, it is possible to prevent the deterioration of the reverse osmosis membrane and the adherence of the organic matters to the reverse osmosis membrane without greatly increasing the cost.

### BRIEF DESCRIPTION OF DRAWINGS

FIG. 1 is a schematic view showing the overall constitution of a water treatment apparatus according to a first embodiment of the present invention.

FIG. 2 is a schematic cross-sectional view showing a sand filtering device according to the first embodiment of the present invention and a peripheral constitution thereof.

FIG. 3A is a schematic cross-sectional view showing a sand filtering device according to a second embodiment of the present invention and a peripheral constitution thereof, and FIG. 3B is an enlarged view of a portion A of FIG. 3A.

FIG. 4 is a schematic cross-sectional view showing a sand filtering device according to a third embodiment of the present invention and a peripheral constitution thereof.

FIG. 5 is a schematic cross-sectional view of a sand filtering device according to a fourth embodiment of the present invention and a peripheral constitution thereof.

### DESCRIPTION OF EMBODIMENTS

Hereinafter, the embodiments of the present invention will be described with reference to drawings. Each of the embodiments described below is just an example, and the application of various modifications or techniques not illustrated in the following embodiments is not excluded. Each of the constitutions of the following embodiments can be embodied by being modified in various ways within a scope that does not depart from the gist of the constitutions. If necessary, the constituents can be selected or unselected, or can be appropriately combined.

In the following description, in a case where there are terms like “upstream” and “downstream”, they mean the upstream and downstream in the circulation direction of the water to be treated.

### 1. First Embodiment

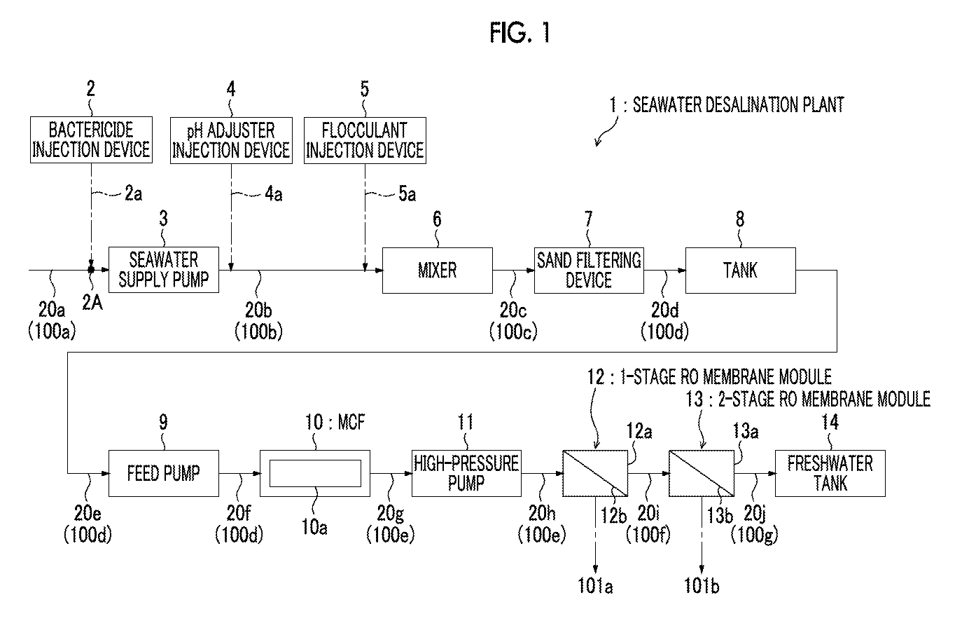

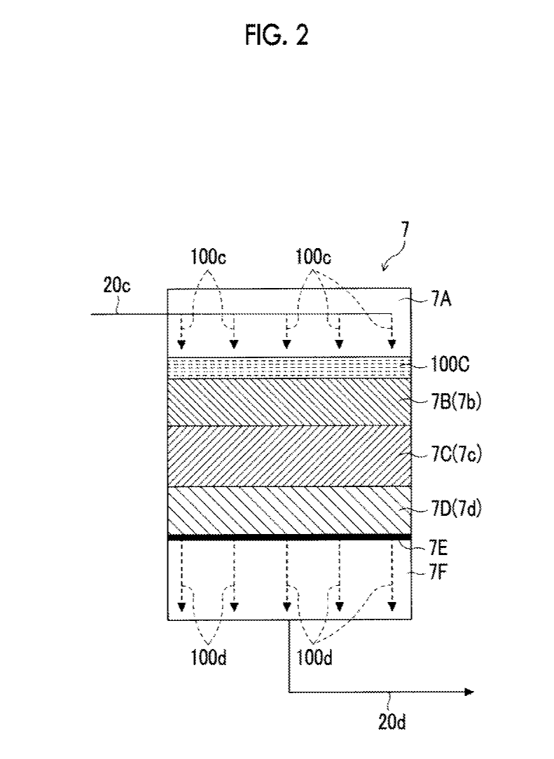

A seawater desalination plant 1 as a first embodiment of the water treatment apparatus of the present invention will be described using FIGS. 1 and 2.

FIG. 1 is a schematic view showing the overall constitution of the water treatment apparatus according to the present embodiment.

FIG. 2 is a schematic cross-sectional view showing a sand filtering device according to the present embodiment and a peripheral constitution thereof.

[1-1. Constitution of Seawater Desalination Plant]

First, the overall constitution of the seawater desalination plant 1 will be described. As shown in FIG. 1, the seawater desalination plant 1 is constituted with, from the upstream side, a seawater supply pump 3, a mixer 6 as an example of mixing acceleration means, a sand filtering device 7, a tank 8, a feed pump 9, a Micron Cartridge Filter (MCF) 10, a high-pressure pump 11, a 1-stage reverse osmosis membrane module (hereinafter, referred to as a 1-stage RO membrane module) 12, a 2-stage reverse osmosis membrane module (hereinafter, referred to as a 2-stage RO membrane module) 13, and a freshwater tank 14 which line up in this order.

On the upstream side of the seawater supply pump 3, a flow channel (hereinafter, referred to as an intake channel as well) 20a is provided into which seawater (hereinafter, referred to as water to be treated as well) 100a as raw water of water to be treated flows. Between each of the constituent instruments 3 and 6 to 14, flow channels 20b to 20j are provided respectively through which wafers to be treated 100b to 100g circulate. The flow channels 20a to 20j are constituted with a pipe, an open conduit, or the like.

The seawater desalination plant 1 further includes a bactericide injection device 2, a pH adjuster injection device 4, and a flocculant injection device 5. The bactericide injection device 2 injects a chlorine-based bactericide 2a into the seawater 100a flowing into the device from the intake channel 20a. The pH adjuster injection device 4 injects a pH adjuster 4a into the water to be treated 100b circulating in the flow channel 20b between the seawater supply pump 3 and the mixer 6. The flocculant injection device 5 injects a flocculant 5a into the water to be treated 100b.

Herein, a plurality of sand filtering devices 7 are arranged in a line, although they are simplified in FIG. 1. The sand filtering devices 7 are arranged in a line such that, even when a single sand filtering device 7 cannot be used due to back washing or maintenance, the seawater desalination plant 1 can be continuously operated by switching the device with another sand filtering device 7.

In the present invention, the flow channel of the water to be treated includes not only the intake channel 20a or the flow channels 20b to 20j between the constituent instruments 3 and 6 to 14 but also a circulation portion of the water to be treated in each of the constituent instruments 3 and 6 to 14. Accordingly, for example, a filter material filling portion of the sand filtering device 7 is also included in the flow channel because the water to be treated circulates in this portion.

Hereinafter, in a case where the flow channels 20a to 20j are not particularly differentiated from each other, they will be called a flow channel 20. In a case where the waters to be treated 100a to 100g are not particularly differentiated from each other, they will be called water to be treated 100.

The seawater desalination plant 1 will be specifically described.

The bactericide injection device 2a injects the chlorine-based bactericide 2a into the seawater 100a flowing into the device from the intake channel 20a in an injection position 2A. As a result, the microorganisms or marine organisms such as shellfishes contained in the seawater 100a are prevented from adhering to and blocking the flow channel 20 or to the circulation portion of each of the constituent instruments 3 and 6 to 14. The chlorine-based bactericide 2a referred herein is sodium hypochlorite (NaClO). Hereinafter, the bactericide will be described as sodium hypochlorite 2a as well.

The bactericide injection device 2a has a function of generating sodium hypochlorite by itself, and includes a seawater electrolyzing tank (not shown in the drawing) for generating sodium hypochlorite from the seawater. In the seawater electrolyzing tank, a direct current is passed through the salt (NaCl)-containing seawater. In this way, chlorine (Cl₂) is generated in an anode, hydrogen (H₂) is generated in a cathode, and at this time, sodium hydroxide (NaOH) is generated. Then, the chlorine and the sodium hydroxide react with each other, and hence sodium hypochlorite is generated (2NaOH+Cl₂→NaCl+NaClO+H₂O).

The salt-containing water supplied to the seawater electrolyzing tank may be allowed to flow into the tank from the flow channels 20a to 20i (preferably flow channels 20a to 20h in which the treated water has a high salt concentration). Alternatively, the seawater may be allowed to directly flow into the tank from the sea through a line different from the flow channel 20. As another option, concentrated water with a high salt concentration that is separated by the RO membrane modules 12 and 13 may be allowed to flow into the tank.

The seawater supply pump 3 causes the seawater 100a to flow into the seawater desalination plant 1 from the intake channel 20a, and supplies the water to be treated (seawater) 100, into which the bactericide 2a has been injected in the intake channel 20a, to the following instruments through the flow channel 20b.

The pH adjuster injection device 4 injects the pH adjuster (herein, sulfuric acid) 4a into the water to be treated 100b circulating in the flow channel 20b. The flocculant injection device 5 injects a flocculant (herein, iron chloride) 5a into the water to be treated 100b on the downstream side from the injection position of the pH adjuster 4a. By the injection of the flocculant 5a, suspended matters contained in the water to be treated 100b can flock and can be effectively trapped by the sand filtering device 7 on the downstream side. The flocking effect of the flocculant 5a is affected by the pH of the water to be treated 100b. Therefore, by the injection of the pH adjuster 4a, the pH of the water to be treated 100b is optimized.

The mixer 6 stirs the water to be treated 100b, into which the bactericide 2a, the pH adjuster 4a, and the flocculant 5a have been injected, and evenly mixing the water to be treated 100b, the bactericide 2a, the pH adjuster 4a, and the flocculant 5a together. As a result, the bactericidal treatment, the pH adjustment, and the flocking treatment of the seawater are effectively performed. As the mixer 6, for example, a line mixer provided in the pipe is used.

The sand filtering device 7 traps the suspended matters flocking due to the action of the flocculant 5a from the water to be treated 100c having passed through the mixer 6.

As shown in FIG. 2, in the sand filtering device 7, the flow channel (hereinafter, referred to as a supply pipe as well) 20c constituted with a pipe is inserted into an upper space 7A of the inside of the sand filtering device 7. The downstream end of the supply pipe 20c is blocked. Furthermore, the lower portion of the circumferential surface of the portion inserted into the sand filtering device 7 is provided with a plurality of injection holes penetrating the pipe wall. As a result, the water to be treated 100c flowing in the supply pipe 20c is injected downwardly from each of the injection holes inside the sand filtering device 7.

Under the supply pipe 20c in the sand filtering device 7, from the top (that is, from the upstream), a first filtering layer 7B formed of anthracite (hereinafter, referred to as a filter material) 7b, a second filtering layer 7C formed of sand (hereinafter, referred to as a filter material) 7c, and a third filtering layer 7D formed of gravels (hereinafter, referred to as a filter material) 7d are provided in this order in a laminated state. Furthermore, a net 7E is transversally provided inside the sand filtering device 7, and the third filtering layer 7D is supported from below by the net 7E.

The second filtering layer 7C is a main layer that filters the water to be treated 100c, and the first filtering layer 7B reduces the load imposed on the second filtering layer 7C by trapping relatively large-sized matters. The third filtering layer 7D is an auxiliary filtering layer and plays a role of supporting the filtering layers 7B and 7C from below and of making the water to be treated 100c or the backwashing water circulate evenly.

The anthracite 7b is not limited to the above. For example, it is possible to use anthracite having an effective size of 1.2 mm and a uniformity coefficient of equal to or less than 1.4.

The sand 7c is not limited to the above. For example, it is possible to use sand having an effective size of 0.6 mm and a uniformity coefficient of equal to or less than 1.4.

The sand filtering device is provided with an outlet (not shown in the drawing) for discharging the backwashing water at the time of backwashing.

On each of the filter materials 7b, 7c, and 7d forming each of the filtering layers 7B, 7C, and 7D, at least one kind of metal or metal compound selected from metals or metal compounds described in the following (1), (2), (3) is supported as a catalyst.

(1) Metals that belong to group 8 elements, group 9 elements, or group 10 elements

(2) Metals that belong to group 2 elements

(3) Hydroxides, oxides, carbonates, and sulfates as metal compounds of the respective metals described in (1) and (2)

Particularly, in view of ease of availability or inexpensiveness, (1) iron is preferable as the metal that belongs to group 8 elements, cobalt is preferable as the metal that belongs to group 9 elements, and nickel is preferable as the metal that belongs to group 10 element; (2) magnesium, calcium, strontium, or barium is preferable as the metal that belongs to group 2 elements; and (3) a hydroxide, an oxide, a carbonate, or a sulfate of iron, cobalt, nickel, magnesium, calcium, strontium, or barium is preferable as the metal compound.

The catalysts supported on the anthracite 7b, the sand 7c, and the gravels 7d do not need to be the same as each other. Accordingly, for example, iron may be supported on the anthracite 7b, cobalt may be supported on the sand 7c, and nickel may be supported on the gravels 7d. Furthermore, the first filtering layer 7B may be formed of a mixture of an iron-supporting anthracite 7b and a cobalt-supporting anthracite 7b.

The method of causing a catalyst to be supported on the filter materials 7b, 7c, and 7d is not limited to the above. For example, it is possible to use a method of coating the surface of the filter materials 7b, 7c, and 7d with a binder and then causing a powdery catalyst to be supported on the surface of the filter materials 7b, 7c, and 7d through a binder.

The water to be treated 100c supplied into the sand filtering device 7 from the supply pipe 20c first forms a water layer 100C on the first filtering layer 7B and then sequentially passes through each of the filtering layers 7B, 7C, and 7D. In this process, the sodium hypochlorite 2a (NaClO) remaining in the water to be treated 100c contacts the catalyst supported on each of the filter materials 7b, 7c, and 7d. As a result, a decomposition reaction shown in the following reaction formula [1] occurs, and NaClO is decomposed into salt and a reactive oxygen radical.

NaClO+CAT→NaCl+(O)[CAT: catalyst, (O): reactive oxygen radical] [1]

The reactive oxygen radical reacts with the organic matters contained in the water to be treated 100c, and as a result, the organic matters are oxidized and decomposed.

Accordingly, while the wafer to be treated 100c is passing through each of the filtering layers 7B, 7C, and 7D, the suspended matters are filtered, and the sodium hypochlorite 2a and the organic matters are also decomposed. That is, the water to be treated 100c becomes the water to be treated 100d from which the suspended matters, the sodium hypochlorite 2a, and the organic matters have been removed. Through the lower space 7F inside the sand filtering device 7 and a flow channel 20d, the water to be treated 100d is sent to the tank 8 of the downstream as shown in FIG. 1 and then temporarily stored in the tank 8.

By the feed pump 9, the water to be treated 100d stored in the tank 8 is aspirated through the flow channel 20e and supplied to the MCF10 through the flow channel 20f.

A cartridge filter (filter material) 10a is set inside the MCF10. The MCF10 removes fine suspended matters and the like failed to be trapped by the sand filtering device 7 from the water to be treated 100d.

The high-pressure pump 11 is for applying pressure, which is equal to or higher than the osmotic pressure, to the 1-st age RO membrane module 12 and the 2-stage RO membrane module 13. The water to be treated 100e from which the fine suspended matters have been removed by the MCF10 is aspirated by the high-pressure pump 11 through the flow channel 20g, undergoes pressure increase by the high-pressure pump 11, and fed by force into the 1-stage RO membrane module 12 through the flow channel 20h.

Herein, a high-pressure pump may be additionally provided between the 1-stage RO membrane module 12 and the 2-stage RO membrane module 13, such that the pressure of equal to or higher than the osmotic pressure is applied to the 2-stage RO membrane module 13 by the high-pressure pump. In a case where the high-pressure pump is provided between the RO membrane modules 12 and 13, the ejection pressure of the high-pressure pump 11 can be further reduced than in a case where the pressure, which is equal to or higher than the osmotic pressure, is applied to both of the RO membrane modules 12 and 13 by only one high-pressure pump 11.

The 1-stage RO membrane module 12 is a module that generates freshwater by desalting the water to be treated 100e, and constituted with a pressure-resistant casing 12a and a 1-stage reverse osmosis membrane (hereinafter, referred to as a 1-stage RO membrane) 12b incorporated into the pressure-resistant casing 12a.

The water to be treated 100e supplied to the 1-stage RO membrane 12b at the pressure of equal to or higher than the osmotic pressure is separated into a less-saline water to be treated (hereinafter, referred to as an intermediate product water as well) 100f which has been desalted by passing through the 1-stage RO membrane 12b and a high-saline concentrated water 101a which remains on the upstream side of the 1-stage RO membrane 12b.

The intermediate product water 100f is supplied to the 2-stage RO membrane module 13 through the flow channel 20i. The concentrated water 101a is supplied to a seawater electrolyzing layer of the bactericide injection device 2 and used for generating the sodium hypochlorite 2a or for backwashing of the sand filtering device 7 or the MCF10.

The 2-stage RO membrane module 13 is a module for further desalting the intermediate product water 100f, and is constituted with a pressure-resistant casing 13a and a 2-stage reverse osmosis membrane (hereinafter, referred to as a 2-stage RO membrane) 13b incorporated into the pressure-resistant casing 13a.

The intermediate product water 100f supplied to the 2-stage RO membrane 13b at the pressure of equal to or higher than the osmotic pressure is separated into a water to be treated (hereinafter, referred to as freshwater) 100g which is a salt-free final water by passing through the 2-stage RO membrane 13b and a salt-containing concentrated water 101b which remains on the upstream side of the 2-stage RO membrane 12b.

The freshwater 100g is supplied to and stored in the freshwater tank 14 through the flow channel 20j. The concentrated water 101b is supplied to the seawater electric field layer of the bactericide injection device 2 and used for generating the sodium hypochlorite 2a or for the backwashing of the sand filtering device 7 or the MCF10.

Herein, as long as the freshwater can be obtained by desalination performed by a single RO membrane module, the RO membrane module may be constituted with only one stage.

[1-2. Desalination Treatment]

A seawater desalination treatment performed by the seawater desalination plant 1 of the present embodiment will be described with reference to FIGS. 1 and 2.

First, the bactericide 2a which is a chlorine-based bactericide, the pH adjuster 4a, and the flocculant 5a are injected into the water to be treated 100, and then the water to be treated 100 is mixed with these by the mixer 6. As a result, the water to be treated 100 is sterilized, and the suspended matters contained in the water to be treated 100 are condensed (flocked).

Then, the condensed suspended matters in the water to be treated 100 are filtered through the sand filtering device 7. At the same time, due to the actin of the filter materials 7b, 7c, and 7d supporting catalysts, the bactericide 2a remaining in the water to be treated 100 causes a decomposition reaction, and due to a reactive oxygen radical generated by the decomposition reaction, the organic matters are decomposed. That is, in the process in which the water to be treated 100 passes through the sand filtering device 7, the suspended matters, the organic matters, and the bactericide 2a are simultaneously removed.

The water to be treated 100 from which the suspended matters, the organic matters, and the bactericide 2a have been removed is supplied to the MCF10 from the tank 8 by the feed pump 9, and the fine suspended matters are removed by the MCF10. The water to be treated 100 then undergoes pressure increase by the high-pressure pump 11, is supplied to the RO membrane modules 12 and 13, becomes freshwater by being desalted by the RO membrane modules 12 and 13, and is stored in the freshwater tank 14.

[1-3. Effect]

According to the seawater desalination plant 1 of the first embodiment, the bactericide 2a injected into the water to be treated 100 causes a decomposition reaction due to the action of the catalysts supported on the filter materials 7b, 7c, and 7d of the sand filtering device 7, and hence the reactive oxygen radical is generated. Due to the reactive oxygen radical, the organic matters in the water to be treated 100 can be oxidized and decomposed. That is, the bactericide 2a and the organic matters can be simultaneously removed.

As a result, it is possible to prevent the RO membranes 12b and 13b from deteriorating due to the bactericide 2a, and to remove the organic matters by using the bactericide 2a that has been injected into the water to be treated 100 in the related art for the purpose of removing marine organisms. Furthermore, the SBS injection facility, which is for removing the chlorine-based bactericide that has been used in the related art, can be omitted. In addition, it is possible to remove the organic matters with a simple constitution in which a catalyst is supported on a filter material.

Consequently, it is possible to prevent the deterioration of the reverse osmosis membrane and the adherence of the organic matters to the reverse osmosis membrane while suppressing an increase of cost.

Having a bactericidal effect, the reactive oxygen radical can inhibit the multiplication of aquatic organisms.

In addition, the radical can prevent the RO membranes 12b and 13b from deteriorating due to the chlorine-based bactericide 2a and can prevent the throughput of the RO membranes 12b and 13b from decreasing due to the adherence of the organic matters. Accordingly, the interval of replacing the RO membranes 12b and 13b with new ones can be lengthened, and the running cost can be reduced.

The mixer 6 is disposed between the injection position 2A of the bactericide 2a and the sand filtering device 7. Accordingly, after the water to be treated 100b is effectively sterilized by being mixed with the bactericide 2a by the mixer 6, the decomposition of the bactericide 2a and the decomposition of the organic matters is performed in the sand filtering device 7 by using the bactericide 2a remaining in the sterilized water to be treated 100c. That is, the sterilization and the decomposition of the organic matters, which are the original purposes of the injection of the bactericide 2a, can be simultaneously achieved.

By causing the catalyst to be supported on the filter materials 7b, 7c, and 7d, the bactericide 2a can be effectively decomposed by the catalyst. That is, because the water to be treated 100c passes through the filter materials 7b, 7c, and 7d over a relatively long period of time, the bactericide 2a remaining in the water to be treated 100c and the catalyst supported on the filter materials 7b, 7c, and 7d can contact each other for a long period of time. As a result, the decomposition of the bactericide 2a and the decomposition of the organic matters can be effectively performed by the catalyst.

The MCF10 is disposed between the sand filtering device 7 and the 1-stage RO membrane module 12. Therefore, even if the catalyst is peeled off from the filter materials 7b, 7c, and 7d of the sand filtering device 7, the peeled catalyst is trapped by the MCF10 before reaching the 1-stage RO membrane modules 12 and 13. Furthermore, for example, even if the catalyst is peeled off from the anthracite 7b, the peeled catalyst is trapped by the anthracite 7b, the sand 7c, or the gravels 7d on the downstream side from the anthracite 7b from which the catalyst has been peeled off (that is, the peeled catalyst is also trapped in the sand filtering device 7). Accordingly, it is possible to prevent the peeled catalyst from adhering to the 1-stage RO membrane module 12 and deteriorating the treatment performance of the 1-stage RO membrane module 12.

If the catalyst is selected from iron, cobalt, nickel, magnesium, calcium, strontium, barium, and hydroxides, oxides, carbonates, and sulfates of these metals, because these metals or metal compounds are easily available and inexpensive, the increase of cost resulting from the use of the catalyst can be suppressed.

[1-4. Others]

In the first embodiment, the catalyst is supported on each of the filter materials, including the anthracite 7b, the sand 7c, and the gravels 7d, of the sand filtering device 7, However, the catalyst may be supported on some of the filter materials 7b, 7c, and 7d. Therefore, for example, among the filter materials 7b, 7c, and 7d, only the anthracite 7b may support the catalyst, only the sand 7c may support the catalyst, or only the gravels 7d may support the catalyst. Alternatively, the catalyst may be supported only on a portion of the anthracite 7b forming the first filtering layer, supported only on a portion of the sand 7c forming the second filtering layer, or supported only some of the gravels 7d forming the third filtering layer.

In the first embodiment, the catalyst is supported on the filter materials 7b, 7c, and 7d of the sand filtering device 7. However, the catalyst may be supported on the cartridge filter 10a of the MCF10 instead of being supported on the filter materials 7b, 7c, and 7d or in addition to the catalyst supported on the filter materials 7b, 7c, and 7d.

### 2. Second Embodiment

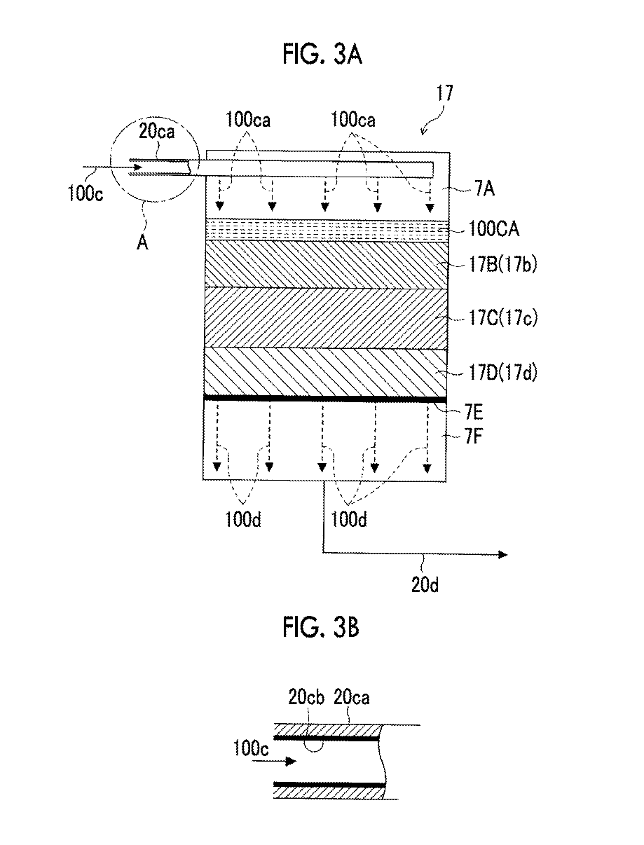

A seawater desalination plant as a second embodiment of the water treatment apparatus of the present invention will be described with reference to FIGS. 3A and 3B. Herein, the same constituents as in the first embodiment are marked with the same reference signs, and the description thereof will not be repeated.

FIG. 3A is a schematic cross-sectional view showing a sand filtering device according to the second embodiment of the present invention and a peripheral constitution thereof. FIG. 3B is an enlarged view of a portion A of FIG. 3A.

[2-1. Constitution of Seawater Desalination Plant]

In the seawater desalination plant 1 of the first embodiment, the catalyst is fixed to the filter materials 7b, 7c, and 7d inside the sand filtering device 7. In contrast, in the seawater desalination plant of the present embodiment, the catalyst is fixed to the inner circumferential surface of a supply pipe 20ca, which supplies the water to be treated to a sand filtering device 17, instead of being fixed to the filter materials 7b, 7c, and 7d.

Hereinafter, the supply pipe 20ca and the sand filtering device 17 according to the present embodiment will be specifically described.

The supply pipe 20ca and the sand filtering device 17 shown in FIGS. 3A and 3B are used instead of the supply pipe 20c and the sand filtering device 7 in the seawater desalination plant 1 of the first embodiment shown in FIGS. 1 and 2.

The inner circumferential surface of the supply pipe 20ca includes a catalyst coating layer 20cb. Herein, the catalyst coating layer 20cb is formed all around the inner circumferential surface of the supply pipe 20ca over the full length of the pipe.

The catalyst contained in the catalyst coating layer 20cb causes a decomposition reaction of the bactericide 2a contained in the water to be treated 100c circulating in the supply pipe 20ca and generates a reactive oxygen radical. The reactive oxygen radical can decompose the organic matters contained in the water to be treated 100c. The metal or the metal compound which can be contained as a catalyst in the catalyst coating layer 20cb is the same as in the first embodiment.

From the water to be treated 100c having passed through the supply pipe 20ca, the bactericide 2a and the organic matters are removed, and the water to be treated 100c becomes a water to be treated 100ca.

In the sand filtering device 17, from the top, a first filtering layer 17B formed of an anthracite (hereinafter, referred to as a filter material as well) 17b, a second filtering layer 17C formed of sand (hereinafter, referred to as a filter material as well) 17c, and a third filtering layer 17D formed of gravels (hereinafter, referred to as a filter material as well) 17d are provided in this order in a laminated state. Furthermore, in the lower portion of the inside of the sand filtering device 17, a net 7E is provided which covers the entirety of the cross-section of the sand filtering device 17. The third filtering layer 17D is supported from below by the net 7E.

Unlike the filter materials 7b, 7c, and 7d of the first embodiment, the filter materials 17b, 17c, and 17d do not support a catalyst. The filter materials 17b, 17c, and 17d are the same as the filter materials 7b, 7c, and 7d of the first embodiment, except that the filter materials 17b, 17c, and 17d do not support a catalyst. Furthermore, the filtering layers 17B, 17C, and 17D are the same as the filtering layers 7B, 7C, and 7D of the first embodiment, except that the filter materials 17b, 17c, and 17d of the filtering layers 17B, 17C, and 17D do not support a catalyst. Therefore, the description thereof will not be repeated.

In addition, because other constitutions of the seawater desalination plant are the same as in the first embodiment, the description thereof will not be repeated.

[2-2. Desalination Treatment]

A desalination treatment according to the present embodiment will be described with reference to FIGS. 3A and 3B.

The water to be treated 100c flowing in the supply pipe 20ca contains the bactericide 2a, the organic matters, and condensed suspended matters. The bactericide 2a is decomposed due to the action of the catalyst coating layer 20cb of the inner circumferential surface of the supply pipe 20ca. The organic matters are decomposed by the reactive oxygen radical generated at the time of decomposition of the bactericide 2a. That is, while flowing in the supply pipe 20ca, the water to be treated 100c becomes a water to be treated 100ca from which the bactericide 2a and the organic matters have been removed. The water to be treated 100ca first forms a water layer 100CA on the filtering layer 17B, and then sequentially passes through the filtering layers 17B, 17C, and 17D. At this time, the condensed suspended matters are trapped, and the bactericide 2a, the organic matters, and the condensed suspended matters are removed. In this way, the water to be treated 100ca becomes a water to be treated 100d.

Other processes of the desalination treatment are the same as in the first embodiment, and hence the description thereof will not be repeated.

[2-3. Effect]

According to the seawater desalination plant of the second embodiment, in addition to the same effect as being obtained by the seawater desalination plant of the first embodiment, the following effects are obtained.

That is, in the first embodiment, the catalyst is supported on the fine filter materials 7b, 7c, and 7d. In contrast, in the present embodiment, the inner circumferential surface of the supply pipe 20ca is simply coated with the catalyst. Therefore, it is easy to fix the catalyst to the flow channel of the water to be treated. Furthermore, in a case where the existing seawater desalination plant is modified to obtain the same constitution as that of the seawater desalination plant of the present embodiment, only the supply pipe 20ca may be modified or changed. Accordingly, the present embodiment has an advantage of being able to be easily obtain the seawater desalination plant by modifying the existing seawater desalination plant.

[2-4. Others]

In the second embodiment, the catalyst coating layer 20cb is formed all around the inner circumferential surface of the supply pipe 20ca over the full length of the pipe. However, as long as the organic matters and the bactericide 2a contained in the water to be treated 100c can be effectively decomposed, the catalyst coating layer 20cb may be formed in only a portion of the inner circumferential surface of the supply pipe 20ca. For example, the catalyst coating layer 20cb may be formed only in the lower half of the inner circumferential surface of the supply pipe 20ca or only in a portion disposed inside the sand filtering device 7.

### 3. Third Embodiment

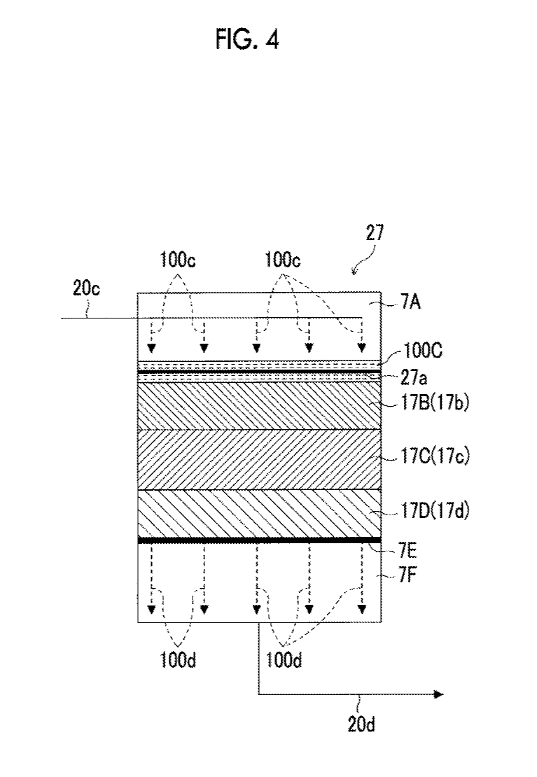

A seawater desalination plant as a third embodiment of the water treatment apparatus of the present invention will be described with reference to FIG. 4. Herein, the same constituents as in each of the embodiments described above are marked with the same reference signs, and the description thereof will not be repeated.

[3-1. Constitution of Seawater Desalination Plant]

In the seawater desalination plant of the second embodiment shown in FIGS. 3A and 3B, the inner circumferential surface of the supply pipe 20ca supplying the water to be treated to the sand filtering device 17 is coated with the catalyst. In contrast, in the seawater desalination plant of the present embodiment, instead of the inner circumferential surface of the supply pipe 20c, a net-like substance 27a provided in a sand filtering device 27 is coated with the catalyst.

Hereinafter, the supply pipe 20c and the sand filtering device 27 according to the present embodiment will be described.

For the seawater desalination plant of the second embodiment, the supply pipe 20c and the sand filtering device 27 shown in FIG. 4 are used instead of the supply pipe 20ca and the sand filtering device 17 of the second embodiment shown in FIGS. 3A and 3B.

The amount of the water to be treated 100c supplied into the sand filtering device 27 per unit time is smaller than the amount of the wafer to be treated 100c passing through the filtering layers 17B, 17C, and 17D per unit time. Therefore, the water to be treated 100c supplied into the sand filtering device 27 from the flow channel 20c first forms the water layer 100C on the first filtering layer 17B.

The net-like substance 27a is disposed such that it sinks in the water layer 100C and separates upwardly from the first filtering layer 17B with a predetermined interval. Furthermore, the net-like substance 27a is disposed in a state of covering the entirety of the cross-section of the sand filtering device 27.

The net-like substance 27a is constituted to have the shape of a lattice of wire rods formed of a metal, plastic, or the like, and the entire surface of the substance is coated with a catalyst. The catalyst causes a decomposition reaction of the bactericide 2a contained in the water layer 100C (water to be treated 100c) and generates a reactive oxygen radical. The metal or the metal compound that can be used as the catalyst is the same as in the first and second embodiments.

The height of the water layer 100C can be predicted based on the amount of the water to be treated 100c supplied per unit time, the amount of the water to be treated 100c passing through the filtering layers 17B, 17C, 17D per unit time, and the cross-sectional area of the upper space 7A. Based on the predicted height of the water layer 100C, the position in which the net-like substance 27a is to be installed can be set such that the substance 27a sinks in the water layer 100C.

[3-2. Desalination Treatment]

A desalination treatment according to the present embodiment will be described with reference to FIG. 4.

The water to be treated 100c forming the water layer 100C contains the bactericide 2a, the organic matters, and the condensed suspended matters. The bactericide 2a is decomposed due to the action of the catalyst with which the surface of the net-like substance 27a is coated. The organic matters are decomposed by the reactive oxygen radical generated at the time of decomposition of the bactericide 2a. That is, in the water layer 100C, the bactericide 2a and the organic matters are removed from the water to be treated 100c.

When the water to be treated, from which the bactericide 2a and the organic matters have been removed, passes through the filtering layers 17B, 17C, and 17D, the suspended matters are filtered, and the water to be treated becomes the water to be treated 100d from which the bactericide 2a, the organic matters, and the suspended matters have been removed.

Other processes of the desalination treatment are the same as in each of the embodiments described above, and hence the description thereof will not be repeated.

[3-3. Effect]

According to the seawater desalination plant of the third embodiment, in addition to the same effect as being obtained from the seawater desalination plant of the first embodiment, the following effects are obtained.

That is, in the first embodiment, the catalyst is supported on the fine filter materials 7b, 7c, and 7d. In contrast, in the present embodiment, only the net-like substance 27a coated with the catalyst is provided, and accordingly, it is easy to fix the catalyst to the flow channel of the water to be treated. Furthermore, in a case where the existing seawater desalination plant is modified to obtain the same constitution as that of the seawater desalination plant of the present embodiment, only the net-like substance 27a may be additionally provided. Therefore, the present embodiment has an advantage in that the seawater desalination plant is easily modified.

In addition, because the net-like substance 27a is in a state of sinking in the water layer 100C, the catalyst, with which the net-like substance 27a is coated, and the water to be treated 100c forming the water layer 100C can contact each other for a long period of time. Consequently, the bactericide 2a and the organic matters can be effectively removed by the action of the catalyst.

[3-4. Others]

In the third embodiment, the net-like substance 27a is disposed such that it separates upwardly from the filtering layer 17B with a predetermined interval. However, the net-like substance 27a may be loaded on the upper surface of the filtering layer 17B.

In the third embodiment, the entire surface of the net-like substance 27a is coated with the catalyst. However, a portion of the surface of the net-like substance 27a (or the surface of the net-like substance 27a excluding a portion thereof) may be coated with the catalyst.

In the third embodiment, the net-like substance 27a is in the form of a lattice using wire rods (that is, a constitution in which wire rods lining up in one direction cross wire rods lining up in the other direction). However, a constitution may be adopted in which all of the wire rods line up in one direction.

In the third embodiment, the net-like substance 27a is constituted with wire rods. However, the net-like substance 27a may be constituted to have a perforated metal shape obtained by providing a plurality of holes in a plate material. In other words, the net-like substance in the present invention also includes those having the perforated metal shape described above.

In the third embodiment, the net-like substance 27a is disposed in a state of sinking in the water layer 100C. However, the net-like substance 27a may be disposed above the water layer 100C. In this case, in order to make the net-like substance 27a and the water to be treated 100c contact each other for a long period of time, it is preferable to further reduce the area of the openings than in a case where the net-like substance 27a is in a state of sinking in the water layer 100C by using the net-like substance 27a having a perforated metal shape. Furthermore, it is preferable to make the water layer 100C formed on the net-like substance 27a.

### 4. Fourth Embodiment

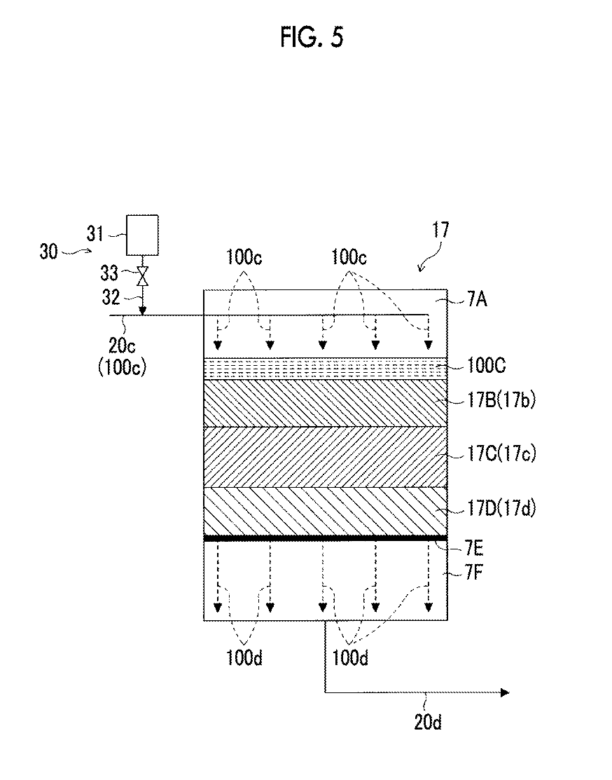

A seawater desalination plant as a fourth embodiment of the water treatment apparatus of the present invention will be described with reference to FIG. 5. Herein, the same constituents as in each of the embodiments described above are marked with the same reference signs, and the description thereof will not be repeated.

FIG. 5 is a schematic cross-sectional view showing a sand filtering device according to the fourth embodiment of the present invention and a peripheral constitution thereof.

[4-1. Constitution of Seawater Desalination Plant]

In the seawater desalination plant of the second embodiment, the inner circumferential surface of the supply pipe 20ca, which supplies the water to be treated to the sand filtering device 17, is coated with the catalyst. In contrast, in the seawater desalination plant of the present embodiment, instead of coating the supply pipe 20ca with the catalyst, a powdery or granular catalyst is supplied into the sand filtering device 17 through the supply pipe 20c.

Hereinafter, the sand filtering device 17 according to the present embodiment and a peripheral constitution thereof will be described.

The sand filtering device 17 according to the present embodiment shown in FIG. 5 has the same constitution as the sand filtering device 17 of the second embodiment shown in FIG. 3A. However, on the outside of the sand filtering device 17, the catalyst is supplied into the supply pipe 20c of the water to be treated 100C from a catalyst supply device (catalyst supply means) 30. As in each of the embodiments described above, the catalyst causes a decomposition reaction of the bactericide 2a contained in the water to be treated 100c and generates a reactive oxygen radical. The metal or the metal compound that can be used as the catalyst is also the same as in each of the embodiments described above.

As shown in FIG. 5, the catalyst supply device 30 is constituted with a catalyst storage portion 31 that stores a powdery or granular catalyst, a pipe 32, and a valve 33 provided in the middle portion of the pipe 32. The catalyst storage portion 31 is disposed vertically above the supply pipe 20c. The internal space of the catalyst storage portion 31 storing the catalyst is in communication with and connected to the inside of the supply pipe 20c through the pipe 32. Due to the aforementioned constitution of the catalyst supply device 30, when the valve 33 is opened, the catalyst in the catalyst storage portion 31 falls into the pipe 32 by gravity and is supplied into the supply pipe 20c.

The catalyst supplied into the supply pipe 20c is supplied into the sand filtering device 17 together with the water to be treated 100c circulating in the supply pipe 20c. Most of the catalyst is disposed in the sand filtering device 17 in the form of being scattered into the water layer 100C or being deposited onto the upper surface of the first filtering layer 17B, while a portion of the catalyst is disposed in the sand filtering device 17 in the form of sinking in each of the 17B, 17C, and 17D.

The valve 33 may be any of a type that is manually opened or closed and a type that is automatically opened or closed. Furthermore, the valve 33 may be any of a type in which a degree of opening can be adjusted continuously or in stages and a type which can only be completely opened or completely closed (that is, an on-off valve).

The catalyst may be appropriately supplied as necessary, intermittently supplied at a predetermined time interval, or continuously supplied all the time.

As the catalyst, the one having a specific gravity greater than the specific gravity (1.40 to 1.60 g/cm³) of the anthracite 17b is used, such that the catalyst is not discharged from the sand filtering device 17 together with the backwashing water when the sand filtering device 17 is subjected to backwashing. That is, because the hydraulic pressure of the backwashing water is set to be a pressure at which the anthracite 17b having the smallest specific gravity among the filter materials 17b, 17c, and 17d is not discharged together with the backwashing water, if a catalyst having a specific gravity greater than that of the anthracite 17b is used, the catalyst is not discharged from the sand filtering device 17 together with the backwashing water.

Other constitutions are the same as those of the seawater desalination plant of the second embodiment, and hence the description thereof will not be repeated.

[4-2. Desalination Treatment]

A desalination treatment according to the present embodiment will be described with reference to FIG. 5.

The bactericide 2a contained in the water to be treated 100c is decomposed due to the action of the catalyst supplied into the sand filtering device 17 from the catalyst supply device 30. The organic matters contained in the water to be treated 100c are decomposed by the reactive oxygen radical generated at the time of decomposition of the bactericide 2a.

Other processes of the desalination treatment are the same as in each of the embodiments described above, and hence the description thereof will not be repeated.

[4-3. Effect]

According to the seawater desalination plant of the fourth embodiment, in addition to the same effect as being obtained from the seawater desalination plant of the first embodiment, the following effects are obtained.

That is, even if the amount of the catalyst is reduced due to the attrition of the catalyst or the like, a new catalyst can be appropriately supplied, and accordingly, the action and effect of the catalyst (the decomposition of the bactericide 2a and the decomposition of the organic matters by the reactive oxygen radical) can last.

The catalyst is supplied to the supply pipe 20c which supplies the water to be treated 100c to the sand filtering device 17. Accordingly, due to the presence of the filter materials 17b, 17c, and 17d, the supplied catalyst does not pass through the sand filtering device 17 and reach the RO membranes 12b and 13b. Consequently, it is possible to prevent the deterioration of the performance of the RO membranes 12b and 13b resulting from the adherence of the catalyst to the RO membranes 12b and 13b.

In addition, because the specific gravity of the catalyst is greater than the specific gravity of the anthracite 17b, the catalyst is not discharged from the sand filtering device 17 together with the backwashing water at the time of backwashing. As a result, it is possible to prevent the catalyst from being unnecessarily discharged and to suppress the increase in running cost.

[4-4. Others]

In the fourth embodiment, the catalyst supply means of the present invention is constituted with the catalyst supply device 30 shown in FIG. 5, but the constitution of the catalyst supply means of the present invention is not limited to the catalyst supply device 30. For example, it is possible for the catalyst storage portion 31 not to be provided in the catalyst supply device 30 (that is, only a portion for supplying the catalyst may be provided in the supply pipe 20c). In this case, in a state were the valve 33 is being opened, the catalyst may be manually injected into the pipe 33. Furthermore, although the catalyst supply device 30 has a constitution in which the catalyst in the catalyst storage portion 31 is supplied to the supply pipe 20c by being caused to fall due to gravity, a constitution may be adopted in which the catalyst is supplied into the supply pipe 20c by being fed by force into the pipe by a pressure fluid.

[5. Others]

(1) In the water treatment apparatus of the present invention, the catalyst disposition site is not limited to the site in each of the embodiments described above, as long as the catalyst is disposed in the flow channel between the injection position 2A of the bactericide 2a injected into the water to be treated and the 1-stage RO membrane 12b.

Here, if the catalyst disposition site is too close to the injection position 2A of the bactericide 2a, the bactericide 2a is decomposed before the wafer to be treated 100a is sufficiently sterilized. Accordingly, it is preferable to estimate the distance long enough for the water to be treated 100a to be sufficiently sterilized, and to install the catalyst in a position that is far away from the injection position 2A of the bactericide 2a by a distance longer than the estimated distance described above. Alternatively, it is preferable to install the catalyst after the water to be treated 100a is mixed with the bactericide 2a by the mixer 6 (that is, on the downstream side from the mixer 6).

If the catalyst adheres to the RO membranes 12b and 13b, the treatment performance of the RO membranes 12b and 13b is likely to deteriorate. Therefore, it is preferable to dispose the catalyst on the upstream side from the MCF10, such that the catalyst is removed before reaching the RO membranes 12b and 13b even when the catalyst is peeled off and flows toward the downstream side.

Examples of the preferred catalyst disposition site satisfying the aforementioned conditions include, in addition to the sites exemplified in the embodiments described above, the inner circumferential surface of each of the flow channels 20d to 20f, the inner circumferential surface of the side wall of the casing accommodating the filter materials 7b, 7c, and 7d of the sand filtering devices 7, 17, and 27, the inner lateral surface of the bottom wall of the same casing, the net 7E of the sand filtering devices 7, 17, and 27, the inner wall surface of the tank 8, and the like. As the aspect in which the catalyst is disposed in the flow channel, any of an aspect in which the position of the catalyst is fixed by means of coating or the like and an aspect in which the catalyst is allowed to move in the flow channel by injection or the like may be adopted.

(2) The aspects of the embodiments described above may be appropriately combined. For example, all of the embodiments descried above may be combined. That is, the catalyst may be fixed to the flow channel 20 by using the filter materials 7b, 7c, and 7d supporting the catalyst, the net-like substance 27a supporting a catalyst may be disposed in the water layer formed on the filter material 7b, and the catalyst may be supplied to the flow channel 20 by providing the catalyst supply device 30.

(3) In each of the embodiments descried above, the water treatment apparatus was described as a seawater desalination plant that makes freshwater by desalting the seawater by using a RO membrane. However, the water treatment apparatus of the present invention is not limited thereto. For example, the present invention can be applied to a water treatment apparatus that makes the water from salt lakes into freshwater by desalting the water by using a RO membrane or a water treatment apparatus that separates impurities from river water or water from reservoirs by using a RO membrane.

### REFERENCE SIGNS LIST

1 seawater desalination plant (water treatment apparatus)
2 bactericide injection device
2a bactericide [sodium hypochlorite (NaClO)]
6 mixer (mixing acceleration means)
7, 17, 27 sand filtering device
7B, 17B first filtering layer
7C, 17C second filtering layer
7D, 17D third filtering layer
7b, 17b anthracite (filter material)
7c, 17c sand (filter material)
7d, 17d gravels (filter material)
10 MCF
10a cartridge filter (filter material)
12 1-stage reverse osmosis membrane module (1-stage RO membrane module)
12b 1-stage reverse osmosis membrane (1-stage RO membrane)
13 2-stage reverse osmosis membrane module (2-stage RO membrane module)
13b 2-stage reverse osmosis membrane (2-stage RO membrane)
20, 20a to 20j, 20ca flow channel
20cb catalyst coating layer
27a net-like substance
30 catalyst supply device (catalyst supply means)
100, 100a to 100g, 100ca water to be treated
100C, 100CA water layer

1-11. (canceled)

12. A water treatment apparatus comprising:
a flow channel in which water to be treated circulates;
bactericide injection means for injecting sodium hypochlorite as a chlorine-based bactericide in an injection position of the flow channel; and
reverse osmosis membrane modules which are disposed in the flow channel on a downstream side from the injection position in a circulation direction of the water to be treated and have reverse osmosis membranes,
wherein in the flow channel, at least one kind of metal or metal compound selected from metals or metal compounds described in the following (1) to (7) is disposed as a catalyst, which decomposes the sodium hypochlorite into salt and a reactive oxygen radical, between the injection position and the reverse osmosis membrane.
(1) iron, a hydroxide of iron, a carbonate of iron, and a sulfate of iron,
(2) a hydroxide of cobalt, a carbonate of cobalt, and a sulfate of cobalt,
(3) a hydroxide of nickel, a carbonate of nickel, and a sulfate of nickel,
(4) magnesium, a hydroxide of magnesium, an oxide of magnesium, a carbonate of magnesium, and a sulfate of magnesium,
(5) calcium, a hydroxide of calcium, an oxide of calcium, a carbonate of calcium, and a sulfate of calcium,
(6) strontium, a hydroxide of strontium, a carbonate of strontium, and a sulfate of strontium,
(7) barium, a hydroxide of barium, an oxide of barium, a carbonate of barium, and a sulfate of barium.

13. The water treatment apparatus according to claim 12,
wherein between the injection position and the catalyst in the flow channel, mixing acceleration means for accelerating mixing of the bactericide with the water to be treated is disposed.

14. The water treatment apparatus according to claim 13,
wherein in the flow channel, a filter material is provided between the mixing acceleration means and the reverse osmosis membrane modules, and
the catalyst is fixed to at least a portion of the filter material.

15. The water treatment apparatus according to claim 13,
wherein in the flow channel, a filter material is provided between the catalyst and the reverse osmosis membrane modules.

16. The water treatment apparatus according to claim 13,
wherein in the flow channel, a filter material is provided between the mixing acceleration means and the reverse osmosis membrane modules, and
the catalyst is fixed to a portion that supplies the water to be treated to the filter material of the flow channel.

17. The water treatment apparatus according to claim 13,
wherein in the flow channel, a filter material is disposed between the mixing acceleration means and the reverse osmosis membrane modules,
a net-likes substance is disposed above the filter material, and
and the catalyst is fixed to the net-like substance.

18. The water treatment apparatus according to claim 17,
wherein the net-like substance is disposed so as to sink in a water layer formed of the water to be treated on the filter material.

19. The water treatment apparatus according to claim 13, further composing:
catalyst supply means for supplying the catalyst to the flow channel.

20. The water treatment apparatus according to claim 19,
wherein in the flow channel, a filter material is provided between the mixing acceleration means and the reverse osmosis membrane modules, and
by the catalyst supply means, the catalyst is supplied to the portion that supplies the water to be treated to the filter material of the flow channel.

21. The water treatment apparatus according to claim 20,
wherein the catalyst has a specific gravity greater than a specific gravity of the filter material.
